(19) United States
(12) Patent Application Publication
(10) Pub. No.: US 2010/0060526 A1
(43) Pub. Date: Mar. 11, 2010

(54) OMNIDIRECTIONAL ANTENNA

(75) Inventor: Chih-Jen CHENG, Taipei City (TW)

Correspondence Address: Workman Nydegger;1000 Eagle Gate Tower, 60 East South Temple, Salt Lake City, UT, 84111, US

(73) Assignee: SMARTANT TELECOM CO., LTD., Jhudong Township (TW)

(21) Appl. No.: 12/204,936

(22) Filed: Sep. 5, 2008

(51) Int. Cl. H01Q 1/38

(52) U.S. Cl. 343/700 MS

(57) ABSTRACT

An omnidirectional antenna includes a substrate, a signal feed-in portion, a first radiation unit, and a second radiation unit. The first radiation unit is located on a first surface of the substrate, and electrically connected to a first circuit of the first surface. The first radiation unit has a first extension end and a second extension end. The second radiation unit is located on a second surface of the substrate, and electrically connected to a second circuit of the second surface. The second radiation unit has a third extension end and a fourth extension end. The first extension end is disposed corresponding to the third extension end, and the second extension end is disposed corresponding to the fourth extension end. The signal feed-in portion is located on the first circuit and the second circuit. Thus, the impedance is improved, a wider bandwidth is achieved, and the process is simplified.

### BACKGROUND OF THE INVENTION

1. Field of Invention

The present invention relates to an antenna, and more particularly to an omnidirectional antenna.

2. Related Art

Along with the development of wireless communication technology, the user may use the wireless communication system to transmit information anywhere. Antenna is an important component in the field of wireless communication. Currently, the PCB method having the advantages of easy fabricating processes and low cost is favored by the antenna manufacturers.

Referring to FIGS. 1A and 1B, FIGS. 1A and 1B are schematic views of a conventional omnidirectional antenna. FIG. 1A is a schematic front view of the conventional omnidirectional antenna, and FIG. 1B is a schematic back view of the conventional omnidirectional antenna. The omnidirectional antenna has a substrate 1, a signal feed-in portion 2, a first circuit 3, a second circuit 4, a first radiation portion 5, and a second radiation portion 6. The second radiation portion 6 is a ground portion.

The conventional omnidirectional antenna has a relative low gain. In order to increase the gain, the open dipole antenna is formed in a manner of serial connection. However, in order to achieve the impedance matching between the radiation units or the ground units connected in series, a wider metal wire may be fabricated in the circuit of the open-circuit dipole antenna to transmit a signal. The wider metal wire reduces a distance between the metal wire and a radiation end of the radiation unit, such that the signal transmitted on the metal wire may affect the signal in the radiation end, which causes a coupling effect between the metal wire and the radiation end.

The coupling effect between the metal wire and the radiation end not only influences the impedance matching between the radiation units, but also causes the limitation to the bandwidth. On the other hand, if the distance between the metal wire and the radiation end is enhanced to avoid the coupling effect between the metal wire and the radiation end, the directivity of the omnidirectional antenna may be overly high.

In order to avoid the problem of the conventional omnidirectional antenna, the connection point of the first radiation unit and the connection point of the second radiation unit are connected in series to the first radiation unit and the second radiation unit by drilling and welding, so as to form a circular loop. By the use of the high impedance characteristic of the dipole antenna having the circular antenna radiation unit, a larger bandwidth than the conventional antenna may be achieved. However, in order to connect the first radiation unit and the second radiation unit, the process difficulty is increased and the yield is reduced accordingly.

The relevant patent is ROC Patent No. M329254.

### SUMMARY OF THE INVENTION

Accordingly, the present invention is directed to an omnidirectional antenna, having the first radiation unit disposed corresponding to the second radiation unit, so as to solve the low gain and narrow bandwidth of the conventional antenna caused by the low impedance, and avoid the decrease of the yield caused by the increase of process difficulty.

The present invention provides an omnidirectional antenna, which includes a substrate, a signal feed-in portion, a first radiation unit, and a second radiation unit. The substrate has a first surface and a second surface. The first surface has a first circuit, and the second surface has a second circuit. The first radiation unit is located on a first surface of the substrate, and electrically connected to a first circuit of the first surface. The first radiation unit has a first extension end and a second extension end. The second radiation unit is located on a second surface, and electrically connected to a second circuit. The second radiation unit has a third extension end and a fourth extension end. The first extension end is disposed corresponding to the third extension end, and the second extension end is disposed corresponding to the fourth extension end. The signal feed-in portion is located on the first circuit and the second circuit for feeding in/out a signal.

A terminal of the first extension end is located at a vertical projection position of a terminal of the third extension end, and a terminal of the second extension end is located at a vertical projection position of a terminal of the fourth extension end. That is, the first extension end overlaps the part of the third extension end, and the second extension end overlaps the part of the fourth extension end, such that the first radiation unit and the second radiation unit form a loop-like closed loop.

In the omnidirectional antenna disclosed in the present invention, the first extension end is disposed corresponding to the third extension end and the second extension end is disposed corresponding to the fourth extension end, and thus the first radiation unit and the second radiation unit form a loop-like closed loop, so as to provide a high impedance and an effect of a high gain and a wide bandwidth, and meanwhile reduce the process difficulty and improve the yield.

Features and advantages of the present invention comprehensible, preferred embodiments accompanied with fingers are described in detail below.

### BRIEF DESCRIPTION OF THE DRAWINGS

The present invention will become more fully understood from the detailed description given herein below for illustration only, and thus are not limitative of the present invention, and wherein:

FIG. 1A is a schematic front view of a conventional omnidirectional antenna;

FIG. 1B is a schematic back view of the conventional omnidirectional antenna;

FIG. 2A is a schematic view of a first surface according to a first embodiment of the present invention;

FIG. 2B is a schematic view of a second surface according to the first embodiment of the present invention;

FIG. 3A is a schematic view of a first surface according to a second embodiment of the present invention;

FIG. 3B is schematic view of a second surface according to the second embodiment of the present invention;

FIG. 4A is a schematic view of a first surface according to a third embodiment of the present invention;

FIG. 4B is a schematic view of a second surface according to the third embodiment of the present invention;

FIG. 5 is a diagram illustrating relationship between directivity and frequency of a field according to the second embodiment of the present invention;

FIG. 6A is a field pattern of horizontal radiation under test at a frequency of 2.4 GHz according to the second embodiment of the present invention;

FIG. 6B is a field pattern of horizontal radiation under test at a frequency of 2.45 GHz according to the second embodiment of the present invention;

FIG. 6C is a field pattern of horizontal radiation under test at a frequency of 2.5 GHz according to the second embodiment of the present invention;

FIG. 6D is a field pattern of horizontal radiation under test at a frequency of 2.55 GHz according to the second embodiment of the present invention;

FIG. 7A is a field pattern of vertical radiation under test at a frequency of 2.4 GHz according to the second embodiment of the present invention;

FIG. 7B is a field pattern of vertical radiation under test at a frequency of 2.45 GHz according to the second embodiment of the present invention;

FIG. 7C is a field pattern of vertical radiation under test at a frequency of 2.5 GHz according to the second embodiment of the present invention; and

FIG. 7D is a field pattern of vertical radiation under test at a frequency of 2.55 GHz according to the second embodiment of the present invention.

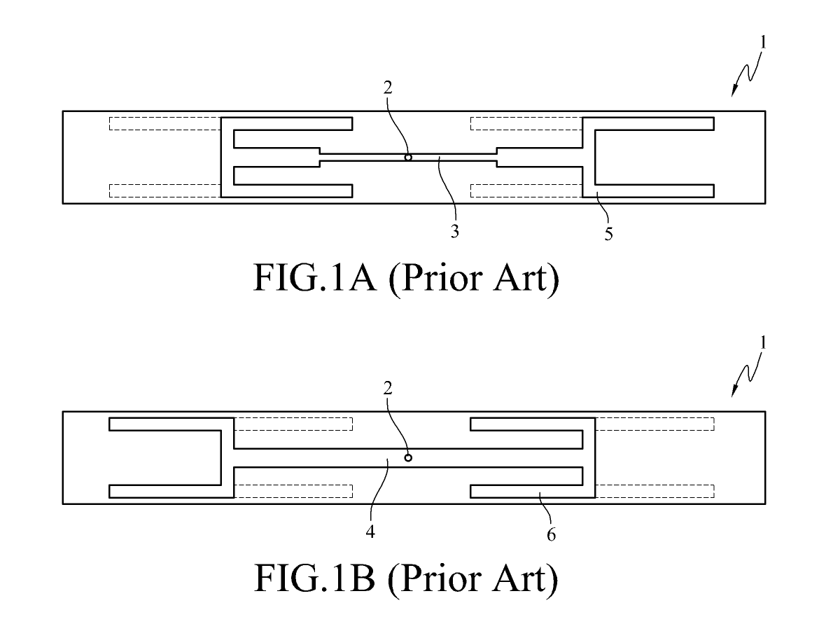

### DETAILED DESCRIPTION OF THE INVENTION

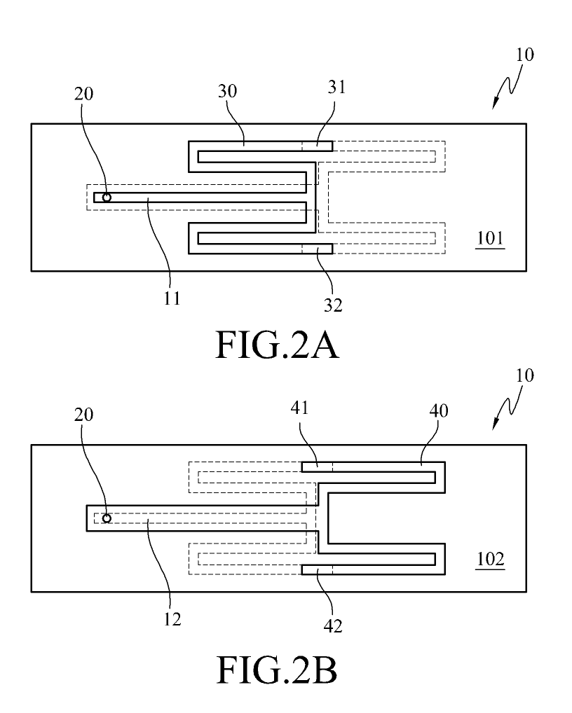

FIGS. 2A and 2B are schematic views according to a first embodiment of the present invention. FIG. 2A is a schematic view of a first surface according to the first embodiment of the present invention, and FIG. 2B is a schematic view of a second surface according to the first embodiment of the present invention. As shown in FIGS. 2A and 2B, the omnidirectional antenna includes a substrate 10, a signal feed-in portion 20, a first radiation unit 30, and a second radiation unit 40.

The substrate 10 has a first surface 101 and a second surface 102. The first surface 101 has a first circuit 11 thereon, and the second surface 102 has a second circuit 12 thereon.

The second circuit 12 overlaps the first circuit 11, but is wider than the first circuit 11. The first circuit 11 has a circuit impedance matching the circuit impedance of the first radiation unit 30. The second circuit 12 has a circuit impedance matching the circuit impedance of the second radiation unit 40. The first circuit 11 is used to transmit the received signal to the first radiation unit 30. The second circuit 12 is used to transmit the received signal to the second radiation unit 40.

The signal feed-in portion 20 is located on the first circuit 11 and the second circuit 12 for feeding in/out a signal of a predetermined frequency band.

The first radiation unit 30 is located on the first surface 101. The first radiation unit 30 is electrically connected to the first circuit 11, and receives or radiates a frequency band signal via the first circuit 11 electrical connected with the signal feed-in portion 20.

The second radiation unit 40 is located on the second surface 102. The first radiation unit 40 is electrically connected to the first circuit 12, and receives or radiates a frequency band signal via the second circuit 12 electrical connected with the signal feed-in portion 20.

The first radiation unit 30 has a first extension end 31 and a second extension end 32, and the second radiation unit 40 has a third extension end 41 and a fourth extension end 42.

The first extension end 31 is disposed corresponding to the third extension end 41, and the second extension end 32 is disposed corresponding to the fourth extension end 42. In this embodiment, a terminal of the first extension end 31 is located at a vertical projection position of a terminal of the third extension end 41, and a terminal of the second extension end 32 is located at a vertical projection position of a terminal of the fourth extension end 42. That is, the first extension end 31 overlaps the part of the third extension end 41, and the second extension end 32 overlaps the part of the fourth extension end 42, such that the first radiation unit 30 and the second radiation unit 40 form a loop-like closed loop.

The first radiation unit 30 may include two first [symbol] -shaped structures and a first connecting circuit. The two first [symbol] -shaped structures are symmetrical about the first circuit 11 that serves as an axis of symmetry, and the first connecting circuit has two ends respectively connected to one end of the two first [symbol] -shaped structures close to the first circuit 11. The first circuit 11 is connected to the first connecting circuit. The first connecting circuit may be vertically connected to the first circuit 11. Furthermore, one end of the two first [symbol] -shaped structures far away from the first circuit 11 has a longer length than the other end close to the first circuit 11.

The second radiation unit 40 may include two second [symbol] -shaped structures and a second connecting circuit. The two second [symbol] -shaped structures are symmetrical about the second circuit 12 that serves as an axis of symmetry, and the second connecting circuit has two ends respectively connected to one end of the two second [symbol] -shaped structures close to the second circuit 12. The second circuit 12 is connected to the second connecting circuit. The second connecting circuit may be vertically connected to the second circuit 12. Furthermore, one end of the two second [symbol] -shaped structures far away from the second circuit 12 has a longer length than the other end close to the second circuit 12.

The first extension end 31 and the second extension end 32 are the end of the two first [symbol] -shaped structures of the first radiation unit 30 far away from the first circuit 11. The third extension end 41 and the fourth extension end 42 are the end of the two second [symbol] -shaped structures of the second radiation unit 40 far away from the second circuit 12.

The first radiation unit 30 and the second radiation unit 40 may be symmetrical geometrical graphs having opposite extending directions and the same shape. The first radiation unit 30 and the second radiation unit 40 may also be asymmetrical geometrical graphs having opposite extending directions and different shapes.

The substrate 10 is normally a PCB or other boards. The substrate 10 may be a rigid plate or a flexible soft plate. The rigid plate may be made of fiberglass or other materials such as bakelite, and the flexible soft plate may be made of polyimide (PI) or other materials such as polyethylene terephthalate (PET).

The signal feed-in portion 20 may be a hole penetrating the substrate 10 from the first circuit 11 of the first surface 101 to the second circuit 12 of the second surface 102.

The first radiation unit 30 may be, but not limited to, in a shape of two connected [symbol] -shaped structures, or geometrical graphs such as elongated shape or finger shape. The second radiation unit 40 may be, but not limited to, in a shape of two connected [symbol] -shaped structures, or geometrical graphs such as elongated shape or finger shape.

In the omnidirectional antenna disclosed in the present invention, the first extension end is disposed corresponding to the third extension end and the second extension end is disposed corresponding to the fourth extension end, the first radiation unit and the second radiation unit form a loop-like closed loop, so as to provide a high impedance and an effect of a high gain and a wide bandwidth, and meanwhile reduce the process difficulty and improve the yield.

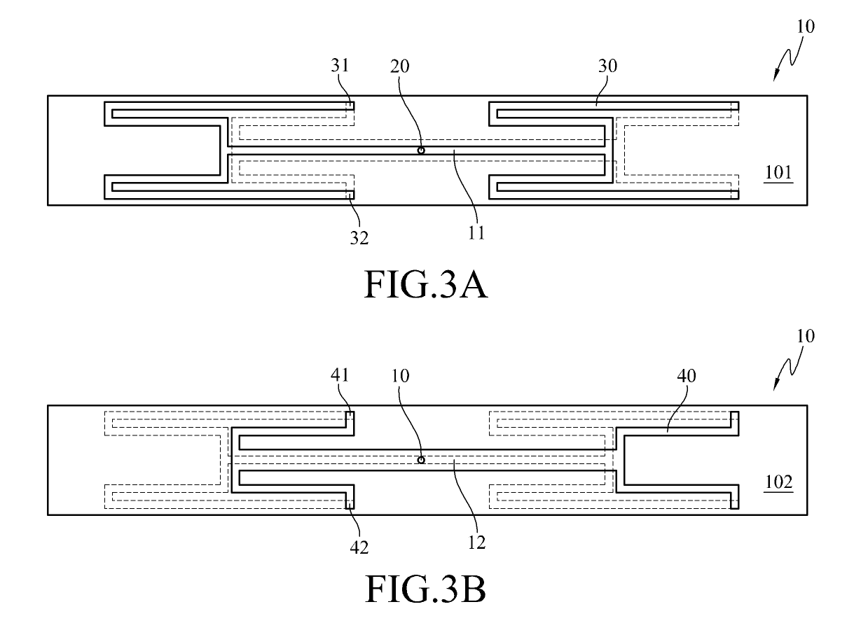

FIGS. 3A and 3B are schematic views according to a second embodiment of the present invention. FIG. 3A is a schematic view of a first surface according to the second embodiment of the present invention and FIG. 3B is schematic view of a second surface according to the second embodiment of the present invention. As shown in FIGS. 3A and 3B, the difference between the second embodiment and the first embodiment of the present invention lies in that, in the second embodiment, the first radiation unit 30 and the second radiation unit 40 are asymmetrical geometrical graphs having different shapes. The other structures in the second embodiment are the same as those in the first embodiment, and will not be repeated herein.

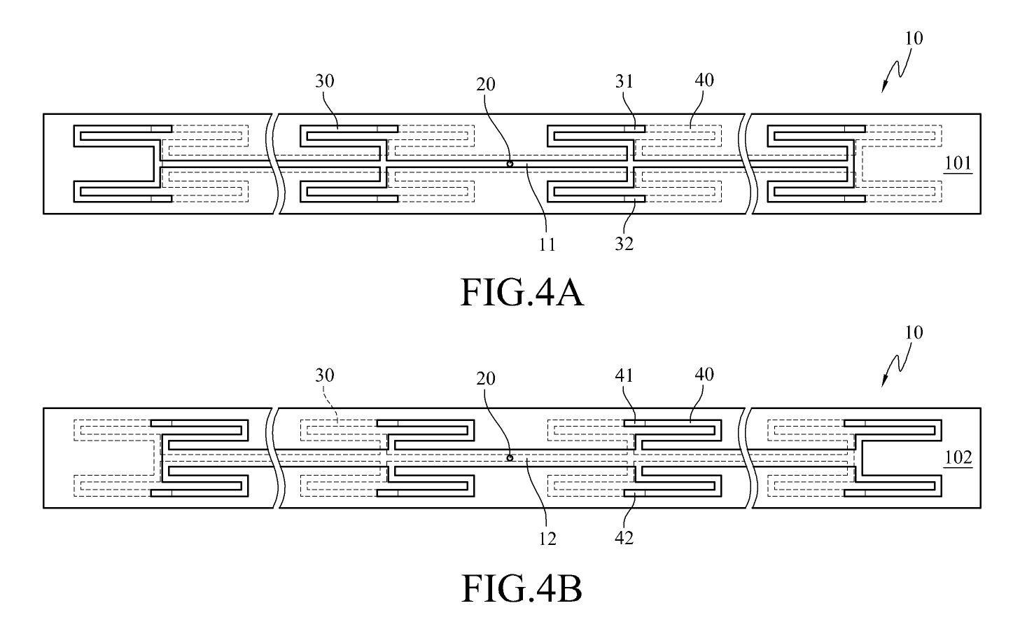

FIGS. 4A and 4B are schematic views according to a third embodiment of the present invention. FIG. 4A is a schematic view of a first surface according to the third embodiment of the present invention, and FIG. 4B is a schematic view of a second surface according to the third embodiment of the present invention. As shown in FIGS. 4A and 4B, the difference between the third embodiment and the first embodiment of the present invention lies in that, the third embodiment has a plurality of first radiation units 30 and a plurality of second radiation units 40, respectively connected in series to form a first antenna array and a second antenna. The antenna array has a signal feed-in portion 20 at a middle position. The other structures are the same as those in the first embodiment, and the details will not be repeated herein. By increasing the number of the first radiation units 30 and the second radiation units 40 connected in series, the signal strength of the omnidirectional antenna may be enhanced.

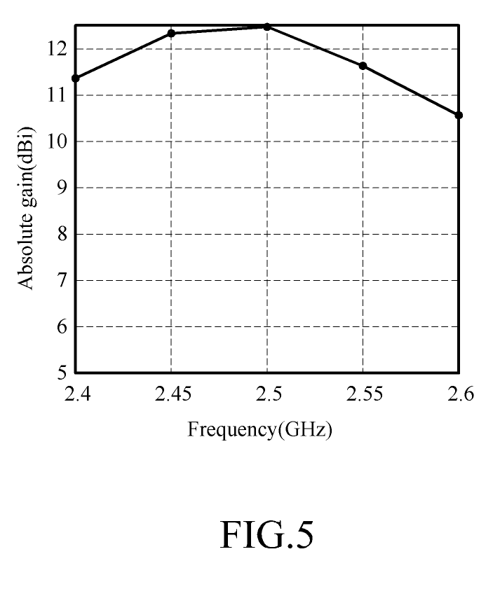

Then, FIG. 5 is a diagram illustrating relationship between directivity and frequency of a field according to the second embodiment of the present invention. Seen from FIG. 5, the frequency is between 2.4 GHz and 2.55 GHz, and the maximum directivity of the signal is maintained above the absolute gain of 11 dBi.

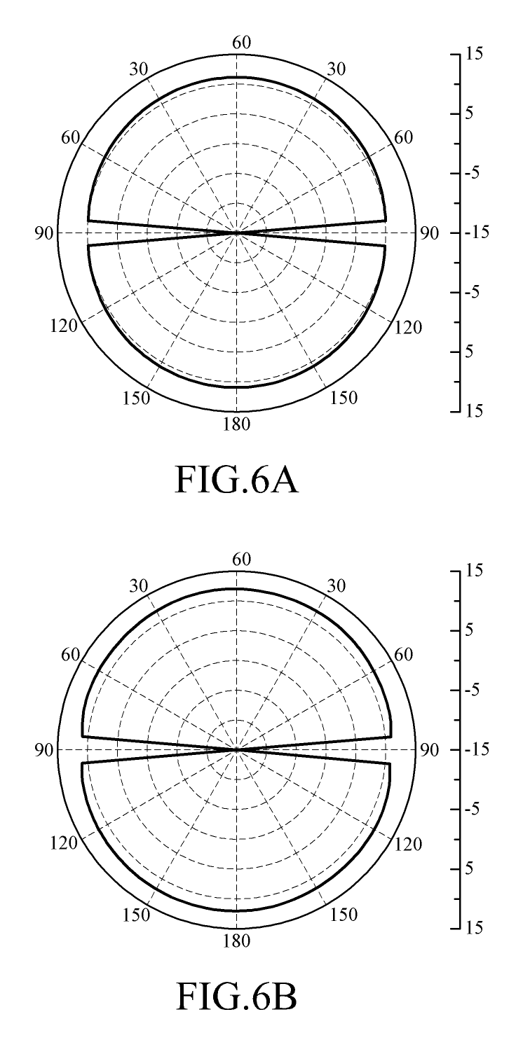

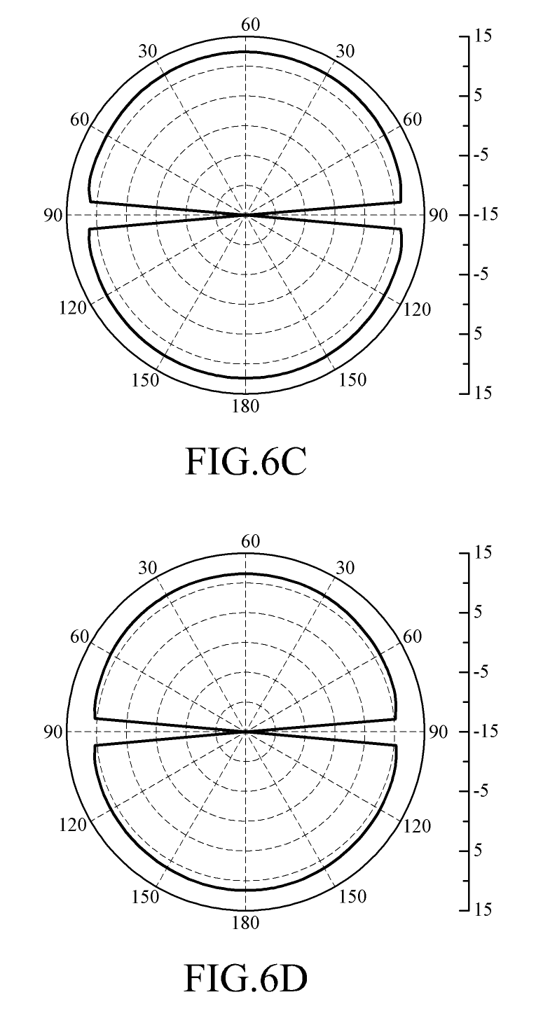

FIGS. 6A, 6B, 6C, and 6D are field patterns of horizontal radiation under test at the frequencies of 2.4 GHz, 2.45 GHz, 2.5 GHz, and 2.55 GHz respectively according to the second embodiment of the present invention. It can be seen from the field patterns that the signals at any angles except those at the two sides of the PCB may be maintained around 11 dB.

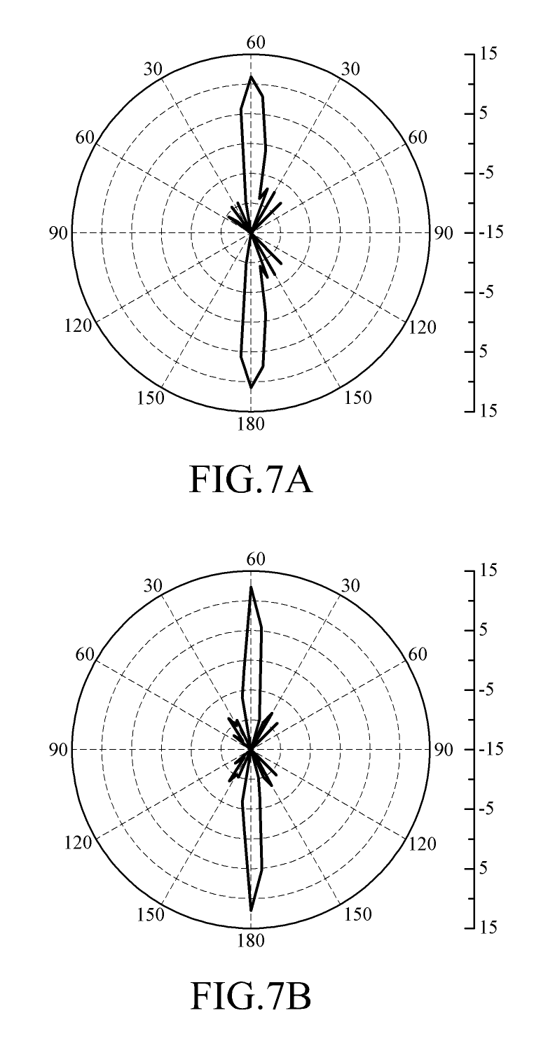

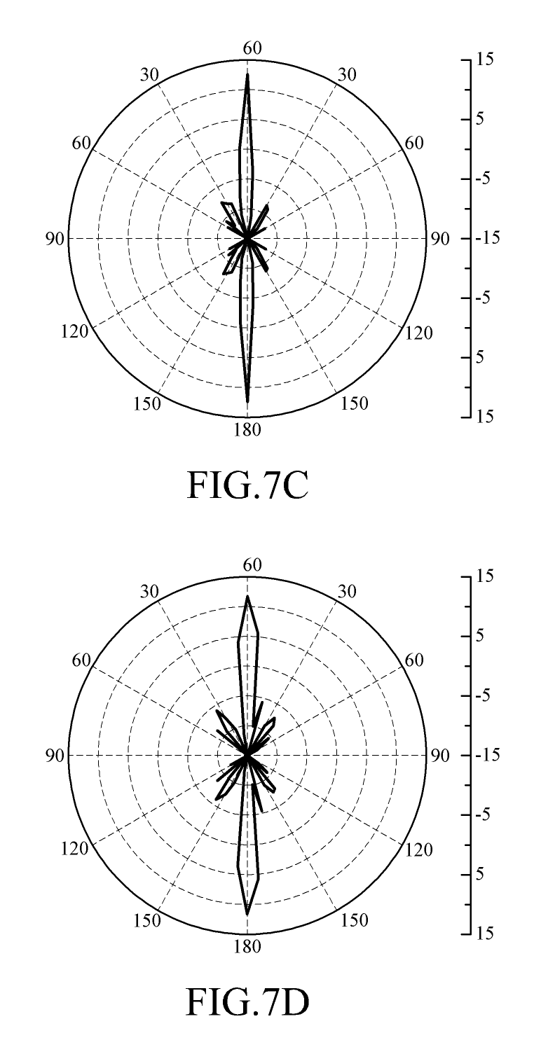

FIGS. 7A, 7B, 7C, and 7D are field patterns of vertical radiation under test at the frequencies of 2.4 GHz, 2.45 GHz, 2.5 GHz, and 2.55 GHz respectively according to the second embodiment of the present invention. It can be seen from the field patterns that the signal strength is centralized at the position of the signal feed-in portion, and gradually descends towards the two ends of the PCB.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An omnidirectional antenna, comprising:
a substrate, having a first surface and a second surface, wherein the first surface has a first circuit, and the second surface has a second circuit;
a signal feed-in portion, located on the first circuit and the second circuit for feeding in/out a signal;
a first radiation unit, located on the first surface and electrically connected to the first circuit, and having a first extension end and a second extension end; and
a second radiation unit, located on the second surface and electrically connected to the second circuit, and having a third extension end and a fourth extension end;
wherein the first extension end is disposed corresponding to the third extension end, and the second extension end is disposed corresponding to the fourth extension end.

2. The omnidirectional antenna according to claim 1, wherein a terminal of the first extension end is located at a vertical projection position of a terminal of the third extension end, and a terminal of the second extension end is located at a vertical projection position of a terminal of the fourth extension end.

3. The omnidirectional antenna according to claim 1, wherein the first radiation unit and the second radiation unit are in a shape of two connected [symbol] -shaped structures, an rectangular shape, or a finger shape.

4. The omnidirectional antenna according to claim 1, wherein the first radiation unit and the second radiation unit have the same shape and are symmetrical in position.

5. The omnidirectional antenna according to claim 1, wherein the first radiation unit and the second radiation unit are asymmetrical geometrical graphs having different shapes.

6. An omnidirectional antenna, comprising:
a substrate, having a first surface and a second surface, wherein the first surface has a first circuit, and the second surface has a second circuit;
a signal feed-in portion, located on the first circuit and the second circuit for feeding in/out a signal;
a plurality of first radiation units, located on the first surface and electrically connected to the first circuit, each having a first extension end and a second extension end; and
a plurality of second radiation units, located on the second surface and electrically connected to the second circuit, each having a third extension end and a fourth extension end;
wherein the first extension end is disposed corresponding to the third extension end, and the second extension end is disposed corresponding to the fourth extension end.

7. The omnidirectional antenna according to claim 6, wherein a terminal of the first extension end is located at a vertical projection position of a terminal of the third extension end, and a terminal of the second extension end is located at a vertical projection position of a terminal of the fourth extension end.

8. The omnidirectional antenna according to claim 6, wherein the first radiation unit and the second radiation unit are in a shape of two connected [symbol] -shaped structures, an rectangular shape, or a finger shape.

9. The omnidirectional antenna according to claim 6, wherein each of the first radiation units and each of the second radiation units have the same shape and are symmetrical in position.

10. The omnidirectional antenna according to claim 6, wherein each of the first radiation units and each of the second radiation units are unsymmetrical geometrical graphs having different shapes.
